(19) United States
(12) Patent Application Publication
(10) Pub. No.: US 2014/0311879 A1
(43) Pub. Date: Oct. 23, 2014

(54) BUTTON ASSEMBLY AND ELECTRONIC DEVICE HAVING THE SAME

(71) Applicants: HON HAI PRECISION INDUSTRY CO., LTD., New Taipei (TW); Fu Tai Hua Industry (Shenzhen) Co., Ltd., Shenzhen (TW)

(72) Inventor: YAN-BANG CAO, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/895,375

(22) Filed: May 16, 2013

(30) Foreign Application Priority Data
Apr. 19, 2013 (CN) 201310137597X

(51) Int. Cl. H01H 3/12

(52) U.S. Cl. CPC H01H 3/12
USPC 200/341

(57) ABSTRACT

An exemplary button assembly for use in an electronic device includes a casing, a switch, a button, a spacer, and a coil spring. The casing is connected to the electronic device. The switch is arranged under the casing. The button is received in the casing. The spacer is received in the casing and arranged between the button and the coil spring. The spacer is attached to the button and configured to actuate the switch when the button is pressed. The coil spring is received in the casing and arranged between the button and the casing. A diameter of the coil spring approximately equals that of the flange of the button, thereby providing an elastic force towards a keystroke axis of the button when the button is released, and the elastic force improves stability of the button while the button is returning to its original position.

### BACKGROUND

1. Technical Field

The present disclosure relates to input devices for electronic apparatus, and more specifically to a button assembly and an electronic device having the button assembly.

2. Description of Related Art

Buttons are widely used in various electronic devices, such as personal digital assistants, mobile phones, and computers. When a typical button is pressed by a user, it actuates a switch on a circuit board. Usually, an arcuate clip is arranged on the button to return the button to its original position when the user releases the button. However, a direction of the elastic force may deviate with respect to the keystroke axis of the button, which can prevent the button from returning to its original position.

Therefore, what is needed is a means to solve the problems described above.

### BRIEF DESCRIPTION OF THE DRAWINGS

FIG. 1 is an isometric view of part of an electronic device, in accordance with an embodiment of the present invention.

FIG. 2 is an exploded, isometric view of the electronic device of FIG. 1.

FIG. 3 is a cross-sectional view of the electronic device of FIG. 1, taken along a line III-III thereof.

### DETAILED DESCRIPTION

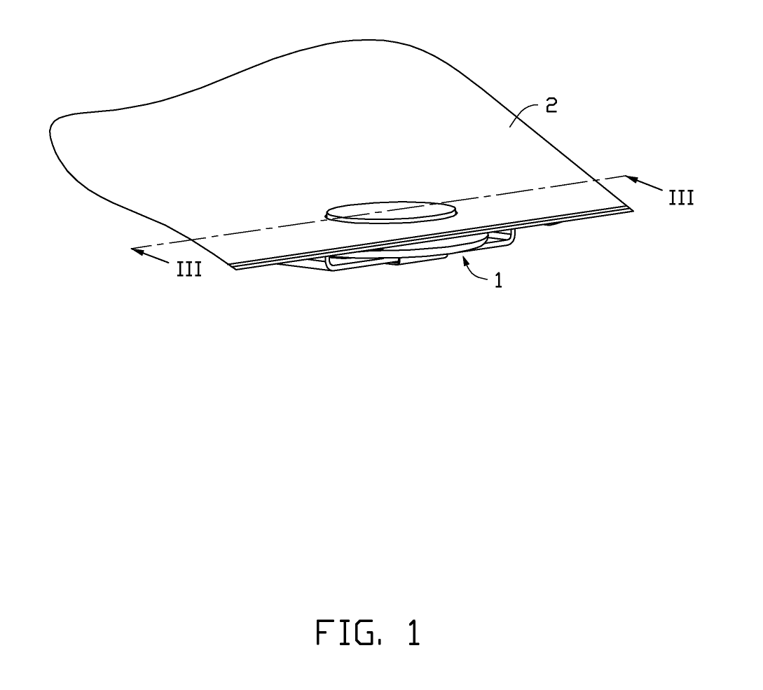

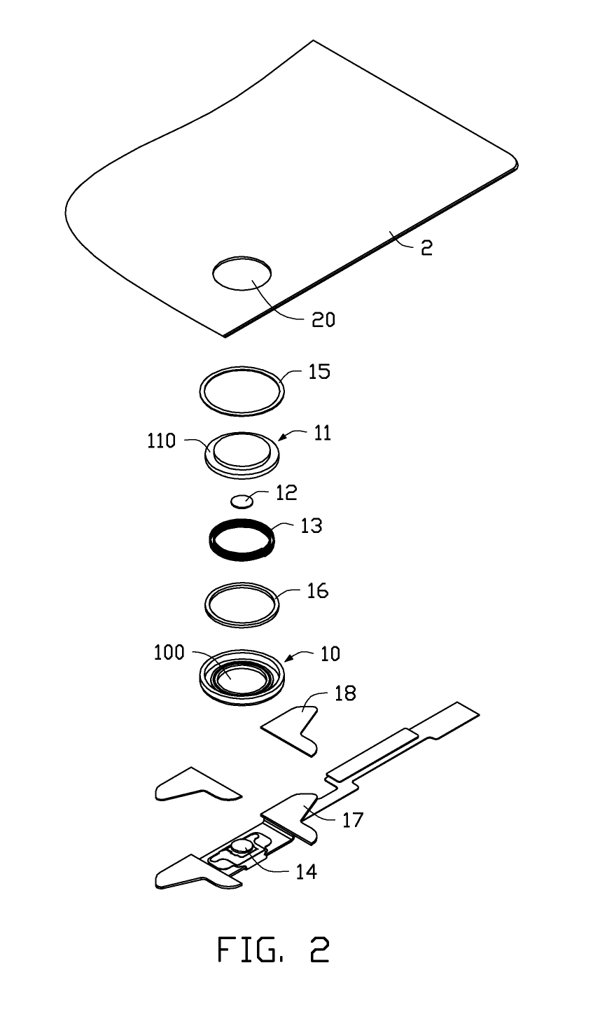

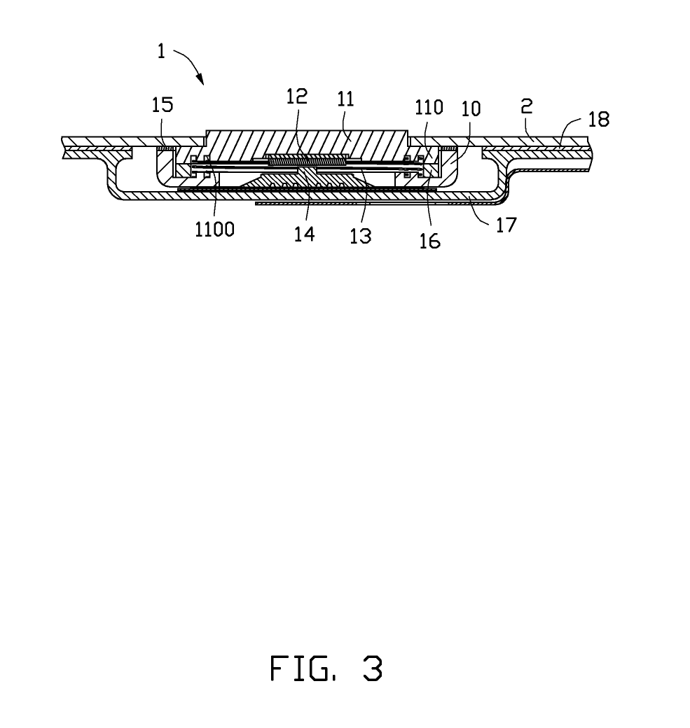

Referring to FIGS. 1-3, an exemplary embodiment of a button assembly 1 is illustrated. The button assembly 1 can be used in various electronic devices (not shown), such as personal digital assistants, mobile phones, and computers. FIGS. 1-3 only schematically show one button assembly 1 for the sake of simplicity. However, in practice, the number of button assemblies 1 employed can be varied according to need.

The button assembly 1 includes a casing 10, a button 11, a spacer 12, a coil spring 13, and a switch 14. The casing 10 is glued to the inner side of a top plate 2 of the electronic device using a first adhesive element 15. In the illustrated embodiment, the first adhesive element 15 is a flat adhesive ring. The button 11, a spacer 12, and a coil spring 13 are movably received in the casing 10. The switch 14 is arranged under the casing 10. The button 11 includes a flange 110 extending around the periphery of a bottom thereof. The size (diameter) of the flange 110 is greater than the size (diameter) of a through hole 20 defined in the top plate 2, thereby preventing the button assembly 1 from disengaging from the top plate 2. The spacer 12 is arranged between the button 11 and the coil spring 13, and is attached to the button 11. The size of the spacer 12 can be varied according to the thickness of the electronic device. An opening 100 is defined in the bottom of the casing 10. The switch 14 is located within the opening 100. The spacer 12 is located above the switch 14. Therefore, when a user presses the button 11, the spacer 12 can move downward and actuate the switch 14. The switch 14 sends a signal to a processor (not shown) of the electronic device to direct the processor to execute a corresponding operation in response.

The coil spring 13 is arranged between the button 11 and the casing 10, and is used to provide a first elastic force when the user releases the button 11. The coil spring 13 is wider than the spacer 12 and slightly narrower than the flange 110. That is, the diameter of the coil spring 13 approximately equals the diameter of the flange 110. Thus the first elastic force provided by the coil spring 13 is substantially parallel to a keystroke axis of the button 11, which improves the stability of the button 11 while the button 11 is returning to its original position. In the embodiment, the flange 110 defines a groove 1100 to receive at least a portion of the coil spring 13, and thus the spring 13 is firmly attached to the button 11.

In the embodiment, the button assembly 1 further includes a foam ring 16 arranged between the flange 110 and the casing 10. The coil spring 13 is received in the foam ring 16. The diameter of the foam ring 16 approximately equals the diameter of the flange 110. Thus, the foam ring 16 can provide a second elastic force to the button 11. The second elastic force is substantially parallel to the keystroke axis of the button 11, which improves the stability of the button 11 while the button 11 is returning to its original position.

In the embodiment, the switch 14 is mounted on a support member 17, which is glued to the inner side of the top plate 2 via a second adhesive element 18. In the illustrated embodiment, the second adhesive element 18 is a pair of flat adhesive sheets. In an alternative embodiment, the support member 17 may be secured to the top plate 2 by bolts.

Although the present disclosure has been described in accordance with the embodiments shown, one of ordinary skill in the art will readily recognize that there could be variations to the embodiments and that those variations would be within the spirit and scope of the present disclosure. Accordingly, many modifications may be made by one of ordinary skill in the art without departing from the spirit and scope of the appended claims.

What is claimed is:

1. A button assembly for use in an electronic device, the button assembly comprising:
a casing connected to a top plate of the electronic device;
a switch arranged under the casing;
a button movably received in the casing, the button comprising a flange;
a spacer movably received in the casing and arranged between the button and the coil spring, the spacer being attached to the button and configured to actuate the switch when the button is pressed; and
a coil spring movably received in the casing, and arranged between the button and the casing;
wherein a diameter of the coil spring approximately equals a diameter of the flange, thereby allowing the coil spring to provide a first elastic force substantially parallel to a keystroke axis of the button when the button is released and urge the button to return to its original position.

2. The button as described in claim 1, wherein the casing is glued to the top plate of the electronic device by a first adhesive element.

3. The button as described in claim 2, wherein the first adhesive element is a flat adhesive ring.

4. The button as described in claim 1, wherein the flange defines a groove receiving at least a portion of the coil spring, and the coil spring is thereby firmly attached to the button.

5. The button as described in claim 1, further comprising a foam ring, wherein the foam ring is arranged between the flange and the casing, the coil spring is received in the foam ring, and a diameter of the foam ring approximately equals the diameter of the flange such that the foam ring provides a second elastic force to urge the button substantially parallel to the keystroke axis of the button.

6. The button as described in claim 1, wherein the switch is mounted on a support member which is glued to the top plate via a second adhesive element.

7. The button as described in claim 1, wherein the switch is mounted on a support member which is secured to the top plate by a plurality of bolts.

8. An electronic device comprising:
a top plate; and
a button assembly comprising:
a casing connected to the top plate of the electronic device;
a switch arranged under the casing;
a button movably received in the casing, the button comprising a flange;
a spacer movably received in the casing and arranged between the button and the coil spring, the spacer being attached to the button and configured to actuate the switch when the button is pressed; and
a coil spring movably received in the casing, and arranged between the button and the casing;
wherein a diameter of the coil spring approximately equals a diameter of the flange, thereby allowing the coil spring to provide a first elastic force substantially parallel to a keystroke axis of the button when the button is released and urge the button to return to its original position.

9. The electronic device as described in claim 8, wherein the casing is glued to the top plate of the electronic device by a first adhesive element.

10. The electronic device as described in claim 9, wherein the first adhesive element is a flat adhesive ring.

11. The electronic device as described in claim 8, wherein the flange defines a groove receiving at least a portion of the coil spring, and the coil spring is thereby firmly attached to the button.

12. The electronic device as described in claim 8, wherein the button assembly further comprises a foam ring arranged between the flange and the casing, the coil spring is received in the foam ring, and a diameter of the foam ring approximately equals the diameter of the flange such that the foam ring provides a second elastic force to urge the button substantially parallel to the keystroke axis of the button.

13. The electronic device as described in claim 8, wherein the switch is mounted on a support member which is glued to the top plate via a second adhesive element.

14. The electronic device as described in claim 8, wherein the switch is mounted on a support member which is secured to the top plate by a plurality of bolts.

15. A button assembly for use in an electronic device, the button assembly comprising:
a casing adapted to be connected to a plate of the electronic device;
a switch arranged at an inner side of the casing;
a button slidably received in the casing, the button comprising a flange;
a spacer movably received in the casing and arranged between the button and the coil spring, the spacer being attached to the button and configured to actuate the switch when the button is pressed; and
a coil spring arranged between the button and the casing;
wherein a diameter of the coil spring approximately equals a diameter of the flange, thereby allowing the coil spring to provide a decompression force substantially parallel to a keystroke axis of the button when the button is released and urge the button to return to an original unpressed position.
